(19) United States
(12) Patent Application Publication
(10) Pub. No.: US 2026/0102296 A1
(43) Pub. Date: Apr. 16, 2026

(54) PLATFORM-BASED MOBILITY ASSISTANCE SYSTEM

(71) Applicant: Gabriel Luna, Patterson, CA (US)

(72) Inventor: Gabriel Luna, Patterson, CA (US)

(21) Appl. No.: 18/917,306

(22) Filed: Oct. 16, 2024

(51) Int. Cl. A61G 5/14

(52) U.S. Cl. CPC A61G 5/14; A61G 2200/16

(57) ABSTRACT

A platform-based mobility assistance system is disclosed. The system includes a platform configured to support multiple seating surfaces, such as a chair and a commode. A movement mechanism, such as rollers and a ball screw actuator, is coupled to the platform to facilitate lateral movement. A support structure, such as a handrail, is fixed to the platform to provide stability to a user during transition between seating surfaces. The system allows a user to transition between seating surfaces by standing with support from the handrail while the platform moves laterally, repositioning the seating surfaces behind the user. This enables users with limited mobility to move between a chair and a commode with minimal physical exertion and without the need to turn, reducing the risk of injury and promoting independence.

### CROSS-REFERENCE TO RELATED APPLICATIONS

Not Applicable

### FIELD OF THE INVENTION

The present disclosure relates generally to mobility assistance devices, and more particularly to a platform-based system for facilitating movement between seating surfaces for individuals with limited mobility.

### BACKGROUND

Individuals with limited mobility, such as the elderly or those recovering from injuries, often face challenges when transitioning between different seating surfaces, particularly between a chair and a commode. Traditional methods typically require the patient to move from a chair to a wheelchair, then to a commode, and back again. This process often involves the patient turning around to get in and out of a sitting position, which can be physically demanding and potentially dangerous for those with limited mobility.

Existing solutions often require extensive movement or turning by the patient, which can be difficult or impossible for some individuals. Additionally, these solutions may require significant assistance from caregivers, potentially compromising the patient's independence and dignity.

There is a need for a system that simplifies the process of transitioning between seating surfaces for individuals with limited mobility, reducing the physical strain and complexity of the process while promoting independence and safety.

### SUMMARY

The present disclosure describes a platform-based mobility assistance system. Various embodiments of the system may include features such as a movable platform, a handrail for support, and a mechanism for repositioning seating surfaces.

In one aspect, a mobility assistance system may include a platform configured to support multiple seating surfaces, a movement mechanism coupled to the platform for facilitating lateral movement, and a support structure fixed to the platform for providing stability to a user during transition between seating surfaces.

In another aspect, a method of facilitating movement between seating surfaces may include supporting a user and multiple seating surfaces on a platform, assisting the user to a standing position using a support structure fixed to the platform, moving the platform laterally to reposition the seating surfaces, and assisting the user to a seated position on a different seating surface without requiring the user to turn.

In yet another aspect, an apparatus for assisting mobility may include a movable base structure, multiple seating surface support areas on the base structure, a user support fixed to the base structure, and a control mechanism for initiating movement of the base structure. Additional features and advantages of the present disclosure will become apparent to those skilled in the art upon consideration of the following detailed description of the illustrative embodiments.

### BRIEF DESCRIPTION OF THE DRAWINGS

The features and advantages of aspects of the present invention will become more apparent from the detailed description set forth below when taken in conjunction with the claims and drawings, in which like reference numbers indicate identical or functionally similar elements. The detailed description particularly refers to the accompanying figures in which:

FIG. 1 illustrates a side view of an exemplary embodiment of the platform-based mobility assistance system, showing the platform, rollers, and handrail.

FIG. 2 illustrates a top view of an exemplary embodiment of the platform-based mobility assistance system, illustrating the platform and fixed handrail.

FIG. 3 illustrates a top view of an alternative embodiment of the platform-based mobility assistance system, showing the platform, a separate turntable, handrail, and curtain connections.

FIG. 4 illustrates a perspective view of an exemplary embodiment of the platform-based mobility assistance system, showing the platform, rollers, handrail, and privacy panels.

FIG. 5 illustrates a perspective view of an alternative embodiment of the platform-based mobility assistance system, illustrating the platform, fixed handrail, turntable, and seating surfaces.

FIG. 6 illustrates an exploded view of the platform-based mobility assistance system, showing the individual components and their assembly.

FIG. 7 illustrates a detailed view of the support structure and handrail of the platform-based mobility assistance system.

FIG. 8 illustrates a cross-sectional view of the platform and movement mechanism of the platform-based mobility assistance system.

FIG. 9 illustrates a schematic diagram of the control system for the platform-based mobility assistance system.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

Reference is made herein to the attached drawings. Like reference numerals may be used in the drawings to indicate like or similar elements of the description. The figures are intended for representative purposes and should not be considered limiting.

The present disclosure can be understood more readily by reference to the following detailed description of the present disclosure and the examples included therein. Before the present articles, systems, devices, and/or methods are disclosed and described, it is to be understood that they are not limited to specific implementations unless otherwise specified, or to particular approaches unless otherwise specified, as such can, of course, vary. It is also to be understood that the terminology used herein is for the purpose of describing aspects only and is not intended to be limiting. Although any methods and materials similar or equivalent to those described herein can be used in the practice or testing of the present disclosure, example methods and materials are now described.

All publications mentioned herein are incorporated herein by reference to disclose and describe the methods and/or materials in connection with which the publications are cited.

### Definitions

It is to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this present disclosure belongs. In this specification and in the claims which follow, reference will be made to a number of terms which shall be defined herein.

As used in the specification and the appended claims, the singular forms “a,” “an,” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; and the number or type of aspects described in the specification.

Disclosed are the components to be used to manufacture the disclosed devices, systems, and articles of the present disclosure as well as the devices themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the present disclosure. Thus, if there are a variety of additional steps that can be performed it is understood that each of these additional steps can be performed with any specific aspect or combination of aspects of the methods of the present disclosure.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

The present disclosure describes a platform-based mobility assistance system, referred to as “Just Stand,” designed to assist individuals with limited mobility in transitioning between a chair and a commode without the need for extensive movement or turning.

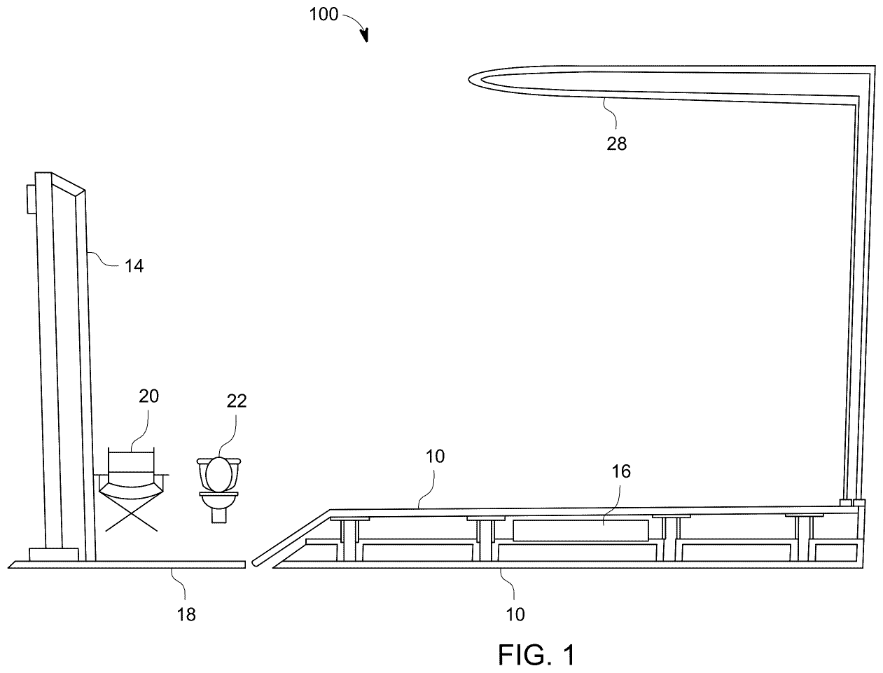

Referring to FIG. 1, a side view 100 an exemplary embodiment of the platform-based mobility assistance system is shown. The system may include a platform 10 that is approximately 3 feet wide and 6.5 feet long. The platform 10 may be supported by four rollers 12 attached to its underside, enabling smooth lateral movement. A handrail 14 may be fixed to the platform 10, providing support for a user during the transition process. The handrail 14 may extend vertically from the platform 10 and may be positioned at a height suitable for user support. A ball screw actuator 16 may be connected to the middle of the platform 10. The ball screw actuator 16 may convert rotational motion to linear motion, enabling the platform 10 to move along rails 18. The rails 18 may be installed on the floor to guide the platform's movement.

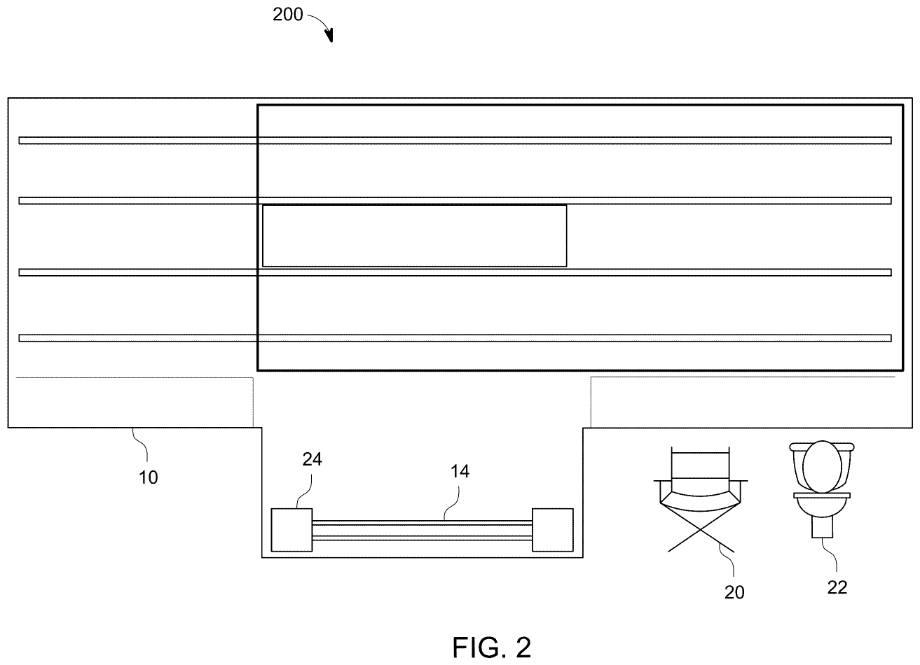

FIG. 2 illustrates a top view 200 of the platform-based mobility assistance system. The platform 10 may include designated areas for positioning a chair 20 and a portable commode 22. The fixed handrail 14 may be clearly visible from this perspective. A control switch 24 may be integrated into the handrail 14 for easy access and operation of the platform movement. The control switch 24 may be connected to the ball screw actuator 16 to initiate and stop the platform's movement.

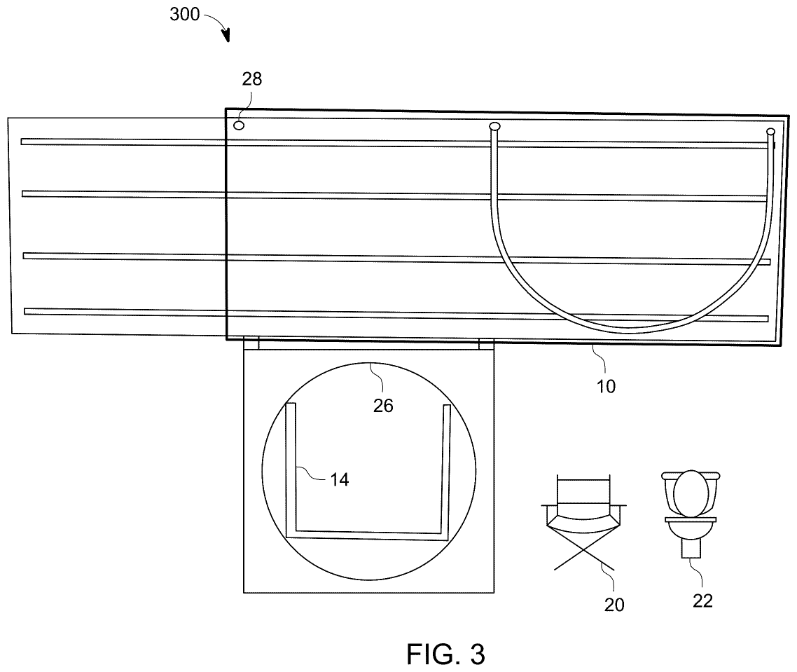

FIGS. 3, 300 shows an alternative embodiment of the system, which may include additional features. A separate turntable 26 may be used in conjunction with the main platform 10. The turntable 26 may provide additional flexibility in positioning the user or seating surfaces. Curtain connections 28 may be provided on the platform 10 or the handrail 14. These connections 28 may allow for the attachment of privacy curtains, enhancing the user's comfort and dignity during use. In operation, a user may initially be seated in the chair 20 positioned on the platform 10. To transition to the commode 22, the user may grasp the handrail 14 for support and stand up.

While the user remains standing and holding onto the handrail 14, a caregiver or the user themselves may activate the control switch 24. Upon activation, the ball screw actuator 16 may engage, causing the platform 10 to move laterally along the rails 18. The platform 10 may move approximately 3 feet, repositioning the chair 20 and commode 22 behind the standing user. Once the platform 10 stops moving, the user may sit down on either the chair 20 or commode 22 without needing to turn. This process may be repeated to transition back to the original seating position.

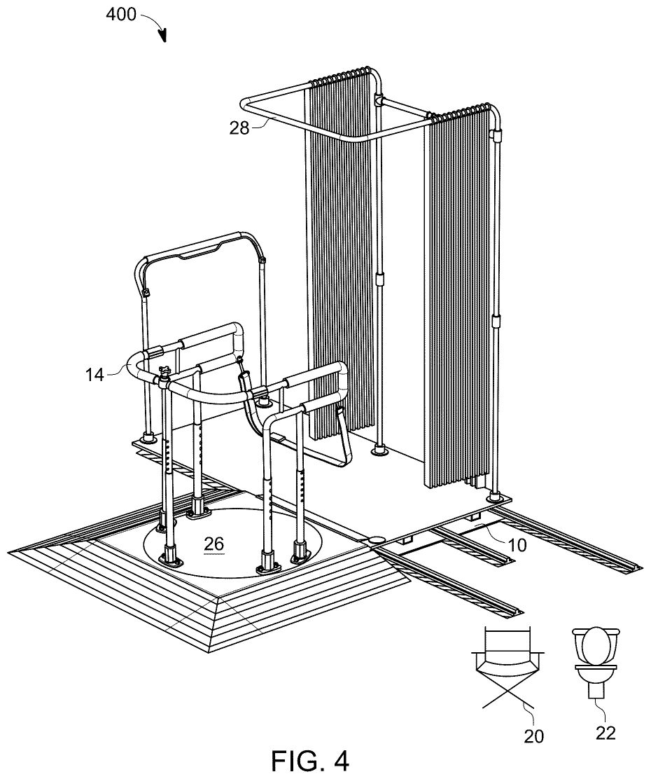

FIG. 4 may depict a mobility assistance system 400 comprising a platform 10 configured to support multiple seating surfaces. The platform 10 may include a circular turntable area 26 towards the front left. A movement mechanism may be coupled to the platform 10 for facilitating lateral movement, which may include a structure with alternating yellow and blue layers below the platform. A support structure 14 may be fixed to the platform 10 for providing stability to a user during transition between seating surfaces. The support structure 14 may include vertical and horizontal interconnected bars. Vertical grey panels 28 may be positioned on the right side of the system. Icons representing a chair 20 and a toilet 22 may be shown at the bottom right.

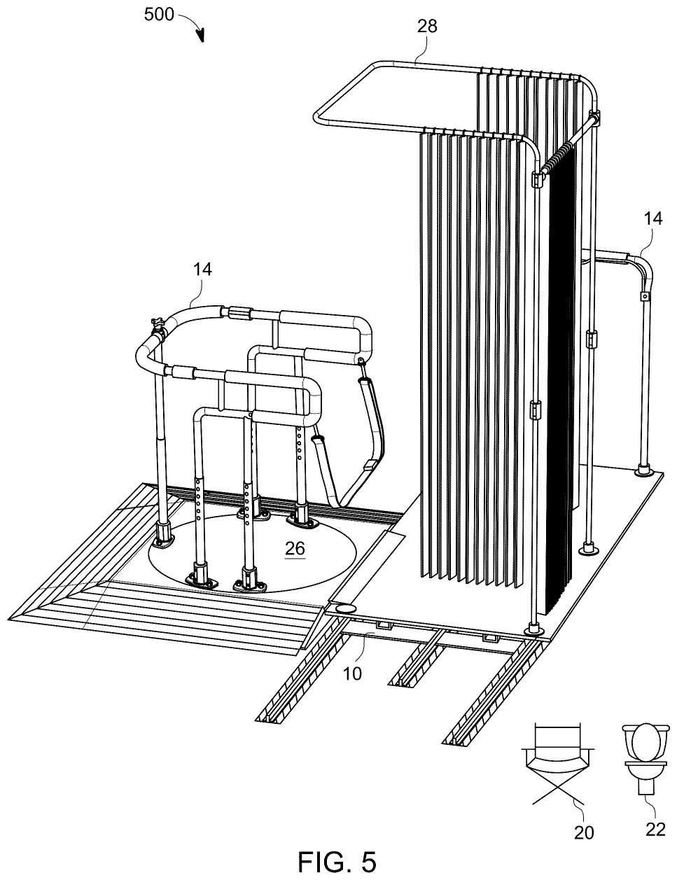

FIG. 5 may illustrate an assembly 500 of a mobility assistance system. The system may comprise a rectangular base platform 10 with various components installed. A turntable section 26 may be located on the left side, potentially surrounded by railings 14 that may connect to vertical supports. A vertical structure 28 resembling a partition or screen may be positioned on the right side. The base may feature yellow and blue stripes. Icons representing a chair 20 and a toilet 22 may be included.

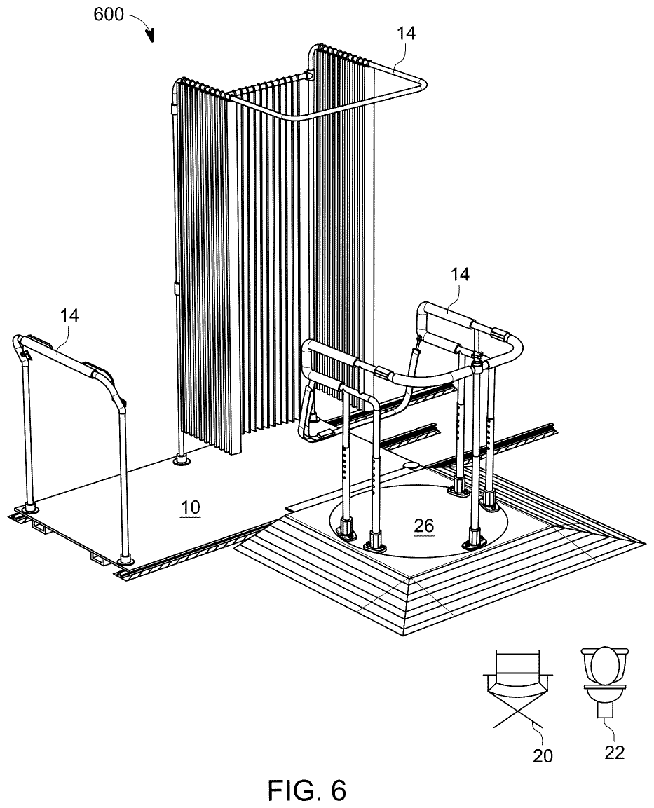

FIG. 6 may show a layout 600 of a mobility assistance system. The system may include a platform 10, potentially representing a support surface. Various components may be depicted, such as bars 14, a vertical panel 28, and a circular component 26 that may represent a turntable. A structure with blue and yellow striped steps or a ramp may lead up to the platform. Icons depicting a seat 20 and a toilet 22 may be included below the main figure.

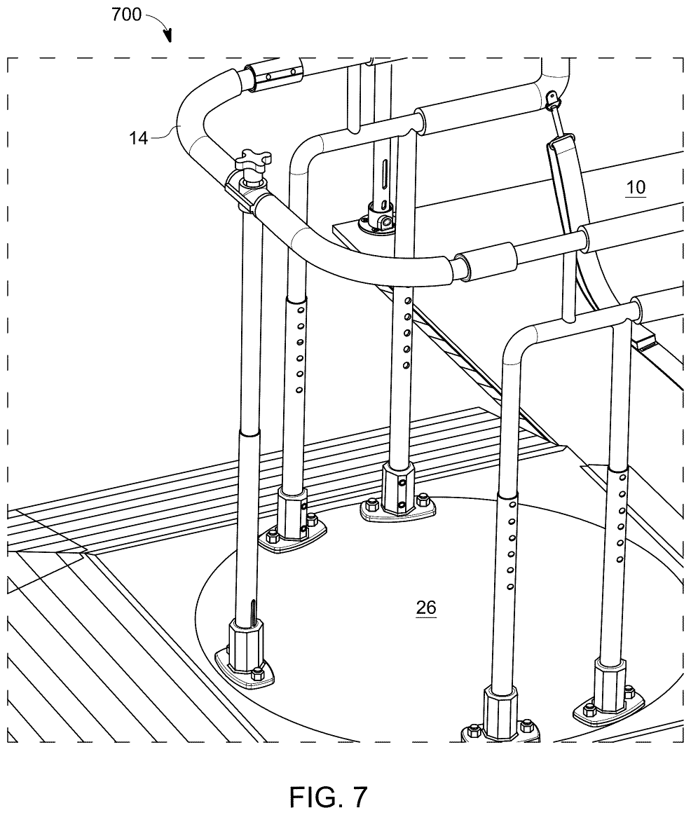

FIG. 7 may present a section 700 of a mobility assistance system. The system may comprise vertical support poles attached to base plates, which may be secured to the ground. These poles may support a network of horizontal bars, potentially interconnected with specific fittings and couplings. One bar may include a component 14, which may be a control mechanism. A swing-like component 10 may also be supported. A surface marked 26 may be visible in the background.

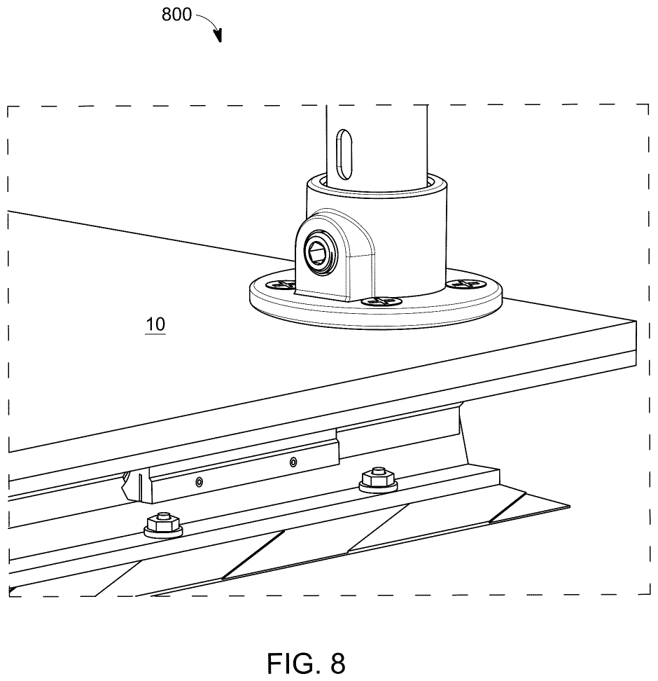

FIG. 8 may provide a detailed view 800 of a component of a mobility assistance system. The component may include a cylindrical part connected to a base plate, which may be mounted on a surface 10. The base plate may be secured with bolts. A vertical cylindrical part with a side protrusion housing an adjustable slot or screw may be fixed to the center of the base plate. Below the surface, there may be a mechanism for additional structural support and stability, featuring a striped pattern.

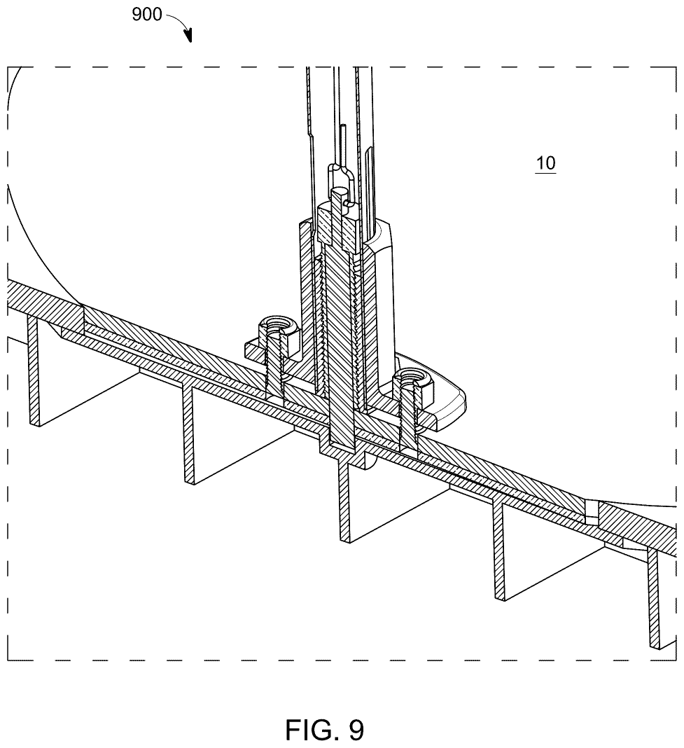

FIG. 9 may illustrate an apparatus 900 that may be part of a mobility assistance system. The figure may show a cross-sectional view of a technical component, potentially revealing internal structures. A section of the apparatus may be labeled as 10, which may correspond to a platform or support surface.

The platform-based mobility assistance system may transform patient mobility by reducing the physical strain and complexity of transitioning between seating surfaces. It may enable users to move between a chair and a commode with minimal physical exertion and reduced risk of injury. The system may be particularly beneficial in home care or medical care environments, specifically designed for use by individuals with limited mobility, the elderly, or those recovering from injuries. It may be used in spaces where a patient needs to transition between a chair and a commode, typically in a bedroom or bathroom setting.

In some embodiments, the platform 10 may be manually moved instead of using the ball screw actuator 16. This may provide a simpler, more cost-effective solution for some users. The platform 10 may be constructed from materials capable of supporting the combined weight of a user, chair, and commode. The surface of the platform 10 may be textured or treated to provide slip resistance. The handrail 14 may be adjustable in height to accommodate users of different statures. It may also be padded or ergonomically designed for enhanced grip and comfort. The system may include safety features such as automatic stop mechanisms to prevent over-travel of the platform 10, and locking mechanisms to secure the platform 10 in place when not in motion.

The platform may be configured to support various seating surfaces and other operating environments. In some embodiments, the platform may accommodate a standard chair or recliner on one end and a portable commode on the other end. The platform may have sufficient surface area and load-bearing capacity to securely hold multiple seating options simultaneously.

In certain embodiments, the platform may be adapted to support specialized medical or assistive seating devices. For example, the platform may be configured to accommodate a wheelchair, hospital bed, lift chair, or other mobility aids. The platform surface may include attachment points or securing mechanisms to safely fasten different types of seating equipment as needed.

The platform may also be suitable for supporting other operating environments beyond just seating surfaces. In some implementations, the platform may incorporate work surfaces, storage compartments, or equipment mounts to create a multi-functional living or care space. For instance, the platform may include a fold-down table, drawer units, or attachment points for medical equipment like IV poles or monitoring devices.

In certain embodiments, the platform surface may feature adjustable or modular sections to accommodate different seating and equipment configurations. Removable panels or inserts may allow the platform to be customized based on the specific needs of the user. The platform may also include anti-slip surfaces or textured areas to enhance stability and safety when transitioning between different seating options.

Various patient populations may be able to benefit from this invention. The mobility assistance system may be particularly useful for elderly individuals who have difficulty with balance or strength when transitioning between seating surfaces. Patients recovering from hip or knee surgeries may find the system helpful during their rehabilitation period, as it reduces the need for twisting motions. Individuals with neurological conditions that affect mobility, such as Parkinson's disease or multiple sclerosis, may also benefit from the simplified transfer process provided by the system.

The platform may be adaptable to accommodate different body types and sizes. In some embodiments, the platform dimensions may be customizable to fit the specific needs of individual users. The handrail height may be adjustable to provide optimal support for users of varying heights. For bariatric patients, the platform and support structure may be reinforced to safely handle higher weight capacities. The platform surface area may also be increased to ensure stability and comfort for larger individuals. Patients with temporary mobility limitations, such as those recovering from sports injuries or accidents, may find the system beneficial during their healing process. The reduced physical strain during transfers may help prevent further injury and promote faster recovery.

In certain embodiments, the system may be configured to support specialized medical equipment. For example, the platform may accommodate oxygen tanks, IV poles, or other necessary medical devices that need to remain close to the patient during transfers. For patients with cognitive impairments, such as dementia or Alzheimer's disease, the simplified transfer process may reduce confusion and anxiety associated with moving between seating surfaces. The consistent positioning of the chair and commode may provide a sense of familiarity and routine.

In some implementations, the system may include additional safety features for patients prone to falls or sudden loss of balance. These features may include emergency stop mechanisms, additional stabilizing supports, or sensors to detect user position and movement. The mobility assistance system may also be beneficial in various care settings beyond private homes. In nursing homes or assisted living facilities, the system may help reduce the physical strain on caregivers during patient transfers. In hospitals or rehabilitation centers, the system may be integrated into patient rooms to facilitate easier transitions between bed, chair, and commode. For patients with visual impairments, the platform and handrail may incorporate high-contrast colors or tactile indicators to improve visibility and spatial awareness during transfers. Audio cues may also be integrated to provide guidance during the transfer process.

The support structure fixed to the platform may be adaptable to work with various seating surfaces and environments. In some implementations, the handrail or support bars may be height-adjustable or removable to accommodate different types of seating. Additional grab bars or support handles may be integrated at strategic locations on the platform to assist with different transfer scenarios. In certain embodiments, the platform may incorporate electrical outlets, data ports, or other connectivity options to support powered seating surfaces or medical equipment. This may allow motorized chairs, adjustable beds, or monitoring devices to remain operational while positioned on the platform.

The movement mechanism coupled to the platform may be designed to provide smooth and stable lateral motion regardless of the specific seating surfaces or operating environment in use. In some implementations, the movement mechanism may include load sensors or automatic leveling features to maintain proper balance and alignment as different equipment configurations are utilized on the platform.

While illustrative embodiments of the invention have been shown and described, variations and alternative embodiments may occur to those skilled in the art. Such variations and alternative embodiments may be made without departing from the scope of the invention as defined in the claims. As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation.

It should be understood that the embodiments described herein are exemplary and that a person skilled in the art may make many variations and modifications without departing from the spirit and scope of the disclosure. All such variations and modifications are intended to be included within the scope of the disclosure as defined in the appended claims.

While illustrative embodiments of the invention have been shown and described, variations and alternative embodiments may occur to those skilled in the art. Such variations and alternative embodiments may be made without departing from the scope of the invention as defined in the claims.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom.

Applicant has made this disclosure with respect to the current state of the art, but also contemplates advancements and that adaptations in the future may take into consideration those advancements in accordance with the then current state of the art. It is intended that the scope of the invention be defined by the claims as written and equivalents as applicable. Reference to a claim element in the singular is not intended to mean “one and only one” unless explicitly so stated. No claim element herein is intended to be construed under the provisions of 35 U.S.C. 112(f), unless the element is expressly recited using the exact phrase “means for. . .” and no method or process step herein is to be construed under the provisions of 35 U.S.C. section 112(f) unless the step, or steps, are expressly recited using the exact phrase “step(s) for. . .”.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Insofar as the description above and the accompanying drawing disclose any additional subject matter that is not within the scope of the claims below, the disclosures are not dedicated to the public and the right to file one or more applications to claims such additional disclosures is reserved. The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

What is claimed is:

1. A mobility assistance system comprising:
a platform configured to support multiple seating surfaces;
a movement mechanism coupled to the platform for facilitating lateral movement; and
a support structure fixed to the platform for providing stability to a user during transition between seating surfaces.

2. The system of claim 1, wherein the platform is approximately 3 feet wide and 6.5 feet long.

3. The system of claim 1, wherein the movement mechanism comprises rollers attached to an underside of the platform.

4. The system of claim 1, wherein the movement mechanism comprises a ball screw actuator connected to the platform.

5. The system of claim 1, further comprising rails installed on a floor to guide movement of the platform.

6. The system of claim 1, wherein the support structure comprises a handrail fixed to the platform.

7. The system of claim 6, further comprising a control switch integrated into the handrail for initiating movement of the platform.

8. The system of claim 1, further comprising a turntable configured to be used in conjunction with the platform.

9. The system of claim 1, further comprising curtain connections for attaching privacy curtains.

10. The system of claim 1, wherein the platform is configured to move approximately 3 feet laterally.

11. A method of facilitating movement between seating surfaces, comprising:
supporting a user and multiple seating surfaces on a platform;
assisting the user to a standing position using a support structure fixed to the platform;
moving the platform laterally to reposition the seating surfaces; and
assisting the user to a seated position on a different seating surface without requiring the user to turn.

12. The method of claim 11, wherein moving the platform laterally comprises activating a ball screw actuator connected to the platform.

13. The method of claim 11, wherein moving the platform laterally comprises manually pushing the platform.

14. The method of claim 11, further comprising activating a control switch to initiate movement of the platform.

15. The method of claim 11, further comprising attaching privacy curtains to curtain connections on the platform.

16. An apparatus for assisting mobility, comprising:
a movable base structure;
multiple seating surface support areas on the base structure;
a user support fixed to the base structure; and
a control mechanism for initiating movement of the base structure.

17. The apparatus of claim 16, wherein the movable base structure comprises a platform supported by rollers.

18. The apparatus of claim 16, wherein the user support comprises a handrail fixed to the base structure.

19. The apparatus of claim 16, further comprising a ball screw actuator for facilitating movement of the base structure.

20. The apparatus of claim 16, further comprising a separate turntable configured to be used in conjunction with the base structure.
